(19) United States
(12) Patent Application Publication
(10) Pub. No.: US 2015/0133125 A1
(43) Pub. Date: May 14, 2015

(54) NORMALIZING LOCATION IDENTIFIERS FOR PROCESSING IN MACHINE LEARNING ALGORITHMS

(71) Applicant: QUALCOMM Incorporated, San Diego, CA (US)

(72) Inventors: Sarah GLICKFIELD, Jerusalem (IL); Isaac David GUEDALIA, Bet Shemesh (IL); Ravinder Paul CHANDHOK, Del Mar, CA (US)

(21) Appl. No.: 14/531,873

(22) Filed: Nov. 3, 2014

Related U.S. Application Data
(60) Provisional application No. 61/901,822, filed on Nov. 8, 2013.

(51) Int. Cl. H04W 64/00; H04W 36/32

(52) U.S. Cl. CPC H04W 64/003; H04W 36/32; H04W 88/08
USPC 455/437; 455/456.5; 455/561

(57) ABSTRACT

The disclosure is related to calculating a relative distance between a first node and a second node in a wireless network. An aspect of the disclosure includes detecting a plurality of transitions of a user device from the first node to the second node, determining a relationship between the first node and the second node based on the plurality of transitions, and calculating the relative distance between the first node and the second node based on the determined relationship.

### CROSS-REFERENCE TO RELATED APPLICATIONS

The present application for patent claims the benefit of Provisional Application No. 61/901,822, entitled “NORMALIZING LOCATION IDENTIFIERS FOR PROCESSING IN MACHINE LEARNING ALGORITHMS,” filed Nov. 8, 2013, which is assigned to the assignee hereof and hereby expressly incorporated by reference herein in its entirety.

### TECHNICAL FIELD

The disclosure is related to normalizing location identifiers for processing in machine learning algorithms.

### BACKGROUND

The Internet is a global system of interconnected computers and computer networks that use a standard Internet protocol suite (e.g., the Transmission Control Protocol (TCP) and Internet Protocol (IP)) to communicate with each other. The Internet of Things (IoT) is based on the idea that everyday objects, not just computers and computer networks, can be readable, recognizable, locatable, addressable, and controllable via an IoT communications network (e.g., an ad-hoc system or the Internet).

A number of market trends are driving development of IoT devices. For example, increasing energy costs are driving governments' strategic investments in smart grids and support for future consumption, such as for electric vehicles and public charging stations. Increasing health care costs and aging populations are driving development for remote/connected health care and fitness services. A technological revolution in the home is driving development for new “smart” services, including consolidation by service providers marketing ‘N’ play (e.g., data, voice, video, security, energy management, etc.) and expanding home networks. Buildings are getting smarter and more convenient as a means to reduce operational costs for enterprise facilities.

There are a number of key applications for the IoT. For example, in the area of smart grids and energy management, utility companies can optimize delivery of energy to homes and businesses while customers can better manage energy usage. In the area of home and building automation, smart homes and buildings can have centralized control over virtually any device or system in the home or office, from appliances to plug-in electric vehicle (PEV) security systems. In the field of asset tracking, enterprises, hospitals, factories, and other large organizations can accurately track the locations of high-value equipment, patients, vehicles, and so on. In the area of health and wellness, doctors can remotely monitor patients' health while people can track the progress of fitness routines.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments disclosed herein in a simplified form to precede the detailed description presented below.

According to one exemplary aspect, the disclosure relates to calculating a relative distance between a first node and a second node in a wireless network. A method for calculating a relative distance between a first node and a second node in a wireless network includes detecting a plurality of transitions of a user device from the first node to the second node, determining a relationship between the first node and the second node based on the plurality of transitions, and calculating the relative distance between the first node and the second node based on the determined relationship.

An apparatus for calculating a relative distance between a first node and a second node in a wireless network includes a wireless transceiver configured to detect a plurality of transitions of a user device from the first node to the second node, and a processor in communication with the wireless transceiver, the processor configured to determine a relationship between the first node and the second node based on the plurality of transitions, and to calculate the relative distance between the first node and the second node based on the determined relationship.

An apparatus for calculating a relative distance between a first node and a second node in a wireless network includes means for detecting a plurality of transitions of a user device from the first node to the second node, means for determining a relationship between the first node and the second node based on the plurality of transitions, and means for calculating the relative distance between the first node and the second node based on the determined relationship.

An apparatus for calculating a relative distance between a first node and a second node in a wireless network includes logic configured to detect a plurality of transitions of a user device from the first node to the second node, logic configured to determine a relationship between the first node and the second node based on the plurality of transitions, and logic configured to calculate the relative distance between the first node and the second node based on the determined relationship.

A non-transitory computer-readable medium for calculating a relative distance between a first node and a second node in a wireless network includes at least one instruction to detect a plurality of transitions of a user device from the first node to the second node, at least one instruction to determine a relationship between the first node and the second node based on the plurality of transitions, and at least one instruction to calculate the relative distance between the first node and the second node based on the determined relationship.

Other objects and advantages associated with the mechanisms disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system in accordance with an aspect of the disclosure.

FIG. 2 illustrates examples of user equipments (UEs) in accordance with embodiments of the disclosure.

FIG. 3 illustrates a communication device that includes logic configured to perform functionality in accordance with an aspect of the disclosure.

FIG. 4 illustrates an exemplary server according to various aspects of the disclosure.

FIGS. 5A-F illustrate how an exemplary transition table is populated with a count of transitions made by a user device between access points A to C.

FIG. 6A illustrates an exemplary process of calculating the distances between the access points A to C of FIGS. 5A-F.

FIG. 6B illustrates the inverted normalized values between access points A to C.

FIG. 7 illustrates a graph mapping input data, i.e., transitions, to centroids.

FIG. 8A illustrates an exemplary user device representation per centroid of FIG. 7.

FIG. 8B illustrates an exemplary centroid representation per user device of FIG. 8A.

FIG. 9 illustrates an exemplary flow for calculating a relative distance between a first node and a second node.

FIG. 10 is another simplified block diagram of several sample aspects of apparatuses configured to support communication as taught herein.

### DETAILED DESCRIPTION

The present application is related to Provisional Application No. 61/769,130, entitled “AN IMPLICIT METHOD FOR CREATING RELATIONSHIPS BETWEEN INTERNET OF THINGS (IOT) DEVICES,” filed Feb. 25, 2013, and assigned to the assignee hereof and hereby expressly incorporated by reference herein.

The disclosure is related to normalizing location identifiers for processing in machine learning algorithms. An aspect of the disclosure is directed to calculating a relative distance between a first node and a second node in a wireless network by detecting a plurality of transitions of a user device from the first node to the second node, determining a relationship between the first node and the second node based on the plurality of transitions, and calculating the relative distance between the first node and the second node based on the determined relationship.

These and other aspects are disclosed in the following description and related drawings to show specific examples relating to exemplary embodiments for normalizing location identifiers for processing in machine learning algorithms. Alternate embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

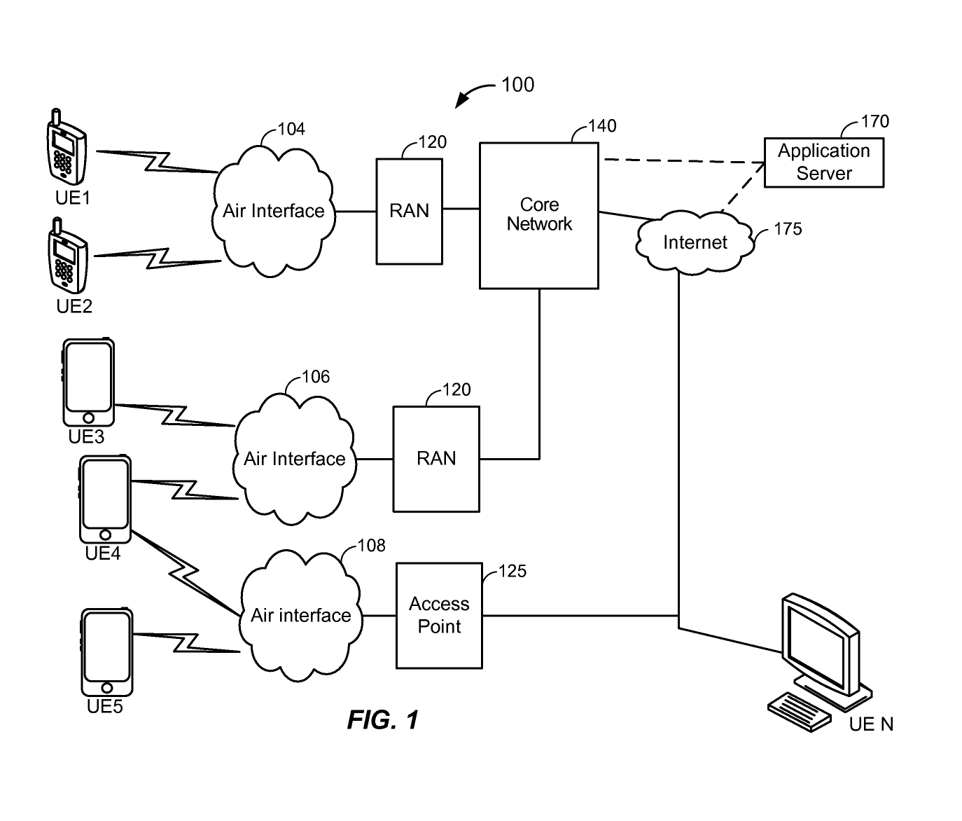

FIG. 1 illustrates a high-level system architecture of a wireless communications system 100 in accordance with an embodiment of the invention. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UEs 1 . . . N via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, a server 170 is shown as connected to the Internet 175, the core network 140, or both. The server 170 can be implemented as a plurality of structurally separate servers, or alternately may correspond to a single server. As will be described below in more detail, the server 170 is configured to support one or more communication services (e.g., Voice-over-Internet Protocol (VoIP) sessions, Push-to-Talk (PTT) sessions, group communication sessions, social networking services, etc.) for UEs that can connect to the server 170 via the core network 140 and/or the Internet 175, and/or to provide content (e.g., web page downloads) to the UEs.

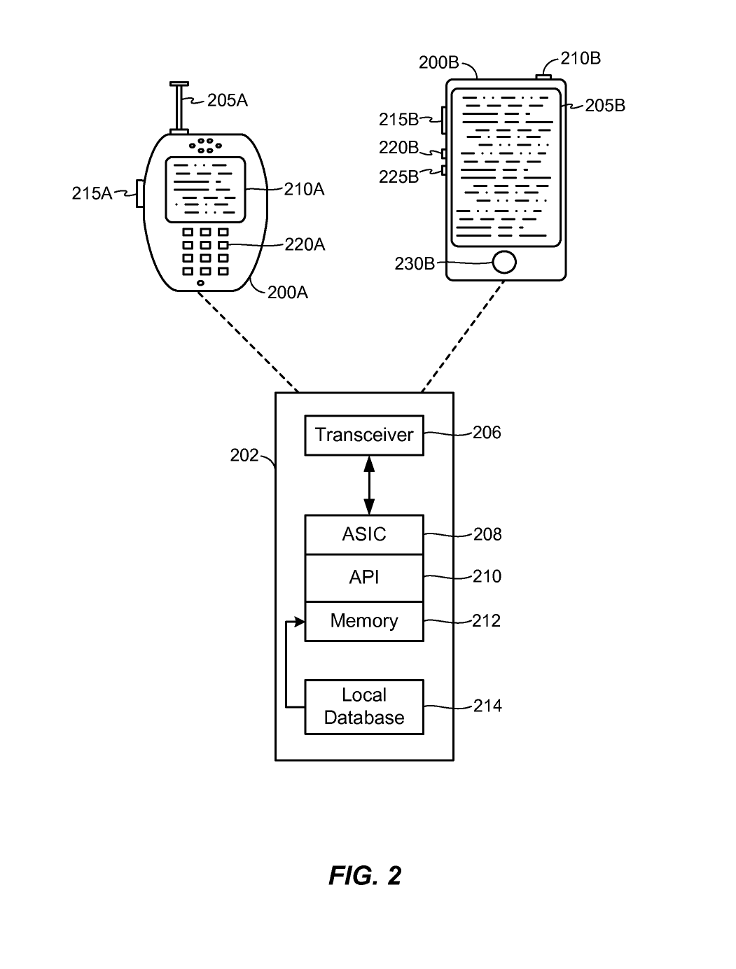

FIG. 2 illustrates examples of UEs (i.e., client devices) in accordance with embodiments of the invention. Referring to FIG. 2, UE 200A is illustrated as a calling telephone and UE 200B is illustrated as a touchscreen device (e.g., a smart phone, a tablet computer, etc.). As shown in FIG. 2, an external casing of UE 200A is configured with an antenna 205A, display 210A, at least one button 215A (e.g., a PTT button, a power button, a volume control button, etc.) and a keypad 220A among other components, as is known in the art. Also, an external casing of UE 200B is configured with a touchscreen display 205B, peripheral buttons 210B, 215B, 220B and 225B (e.g., a power control button, a volume or vibrate control button, an airplane mode toggle button, etc.), at least one front-panel button 230B (e.g., a Home button, etc.), among other components, as is known in the art. While not shown explicitly as part of UE 200B, the UE 200B can include one or more external antennas and/or one or more integrated antennas that are built into the external casing of UE 200B, including but not limited to WiFi antennas, cellular antennas, satellite position system (SPS) antennas (e.g., global positioning system (GPS) antennas), and so on.

While internal components of UEs such as the UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., application server 170, web URLs, etc.). The platform 202 can also independently execute locally stored applications without RAN interaction. The platform 202 can include a transceiver 206 operably coupled to an application specific integrated circuit (ASIC) 208, or other processor, microprocessor, logic circuit, or other data processing device. The ASIC 208 or other processor executes the application programming interface (API) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can store applications not actively used in memory 212, as well as other data. The local database 214 is typically a flash memory cell, but can be any secondary storage device as known in the art, such as magnetic media, EEPROM, optical media, tape, soft or hard disk, or the like.

Accordingly, an embodiment of the invention can include a UE (e.g., UE 200A, 200B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UEs 200A and 200B in FIG. 2 are to be considered merely illustrative and the invention is not limited to the illustrated features or arrangement.

For example, where the UE 200A and/or 200B is configured to calculate a relative distance between a first node and a second node in a wireless network, the transceiver 206 may be configured to detect a plurality of transitions of the UE 200A and/or 200B from the first node to the second node. The ASIC 208 may be configured to determine a relationship between the first node and the second node based on the plurality of transitions and calculate the relative distance between the first node and the second node based on the determined relationship. The transceiver 206 may be configured to share the determined relationships and/or calculated relative distances with one or more other devices.

The wireless communication between the UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

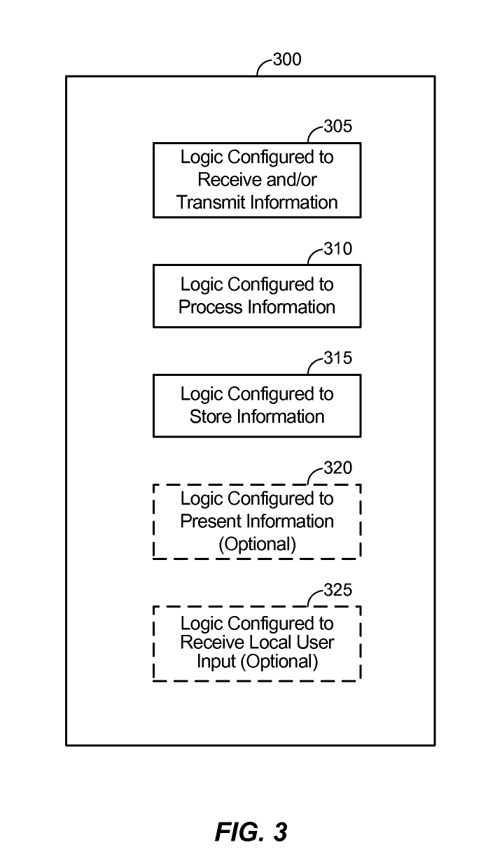

FIG. 3 illustrates a communication device 300 that includes logic configured to perform functionality. The communication device 300 can correspond to any of the above-noted communication devices, including but not limited to UEs 200A or 200B, any component of the RAN 120, any component of the core network 140, any components coupled with the core network 140 and/or the Internet 175 (e.g., the server 170), and so on. Thus, communication device 300 can correspond to any electronic device that is configured to communicate with (or facilitate communication with) one or more other entities over the wireless communications system 100 of FIG. 1.

Referring to FIG. 3, the communication device 300 includes logic configured to receive and/or transmit information 305. In an example, if the communication device 300 corresponds to a wireless communications device (e.g., UE 200A or 200B, AP 125, a BS, Node B or eNodeB in the RAN 120, etc.), the logic configured to receive and/or transmit information 305 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., server 170, etc.), the logic configured to receive and/or transmit information 305 can correspond to an Ethernet card, in an example, that connects the network-based server to other communication entities via an Ethernet protocol. For example, where the communication device 300 is configured to calculate a relative distance between a first node and a second node in a wireless network, the logic configured to receive and/or transmit information 305 may be configured to detect a plurality of transitions of a user device from the first node to the second node. In a further example, the logic configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, the logic configured to receive and/or transmit information 305 does not correspond to software alone, and the logic configured to receive and/or transmit information 305 relies at least in part upon hardware to achieve its functionality.

Referring to FIG. 3, the communication device 300 further includes logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, where the communication device 300 is configured to calculate a relative distance between a first node and a second node in a wireless network, the logic configured to process information 310 may be configured to determine a relationship between the first node and the second node based on the plurality of transitions and calculate the relative distance between the first node and the second node based on the determined relationship. The processor included in the logic configured to process information 310 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 310 can also include software that, when executed, permits the associated hardware of the logic configured to process information 310 to perform its processing function(s). However, the logic configured to process information 310 does not correspond to software alone, and the logic configured to process information 310 relies at least in part upon hardware to achieve its functionality.

Referring to FIG. 3, the communication device 300 further includes logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM memory, flash memory, ROM memory, EPROM memory, EEPROM memory, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, the logic configured to store information 315 does not correspond to software alone, and the logic configured to store information 315 relies at least in part upon hardware to achieve its functionality.

Referring to FIG. 3, the communication device 300 further optionally includes logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to UE 200A or UE 200B as shown in FIG. 2, the logic configured to present information 320 can include the display 210A of UE 200A or the touchscreen display 205B of UE 200B. In a further example, the logic configured to present information 320 can be omitted for certain communication devices, such as network communication devices that do not have a local user (e.g., network switches or routers, remote servers such as the server 170, etc.). The logic configured to present information 320 can also include software that, when executed, permits the associated hardware of the logic configured to present information 320 to perform its presentation function(s). However, the logic configured to present information 320 does not correspond to software alone, and the logic configured to present information 320 relies at least in part upon hardware to achieve its functionality.

Referring to FIG. 3, the communication device 300 further optionally includes logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to UE 200A or UE 200B as shown in FIG. 2, the logic configured to receive local user input 325 can include the keypad 220A, any of the buttons 215A or 210B through 225B, the touchscreen display 205B, etc. In a further example, the logic configured to receive local user input 325 can be omitted for certain communication devices, such as network communication devices that do not have a local user (e.g., network switches or routers, remote servers such as the server 170, etc.). The logic configured to receive local user input 325 can also include software that, when executed, permits the associated hardware of the logic configured to receive local user input 325 to perform its input reception function(s). However, the logic configured to receive local user input 325 does not correspond to software alone, and the logic configured to receive local user input 325 relies at least in part upon hardware to achieve its functionality.

Referring to FIG. 3, while the configured logics of 305 through 325 are shown as separate or distinct blocks in FIG. 3, it will be appreciated that the hardware and/or software by which the respective configured logic performs its functionality can overlap in part. For example, any software used to facilitate the functionality of the configured logics of 305 through 325 can be stored in the non-transitory memory associated with the logic configured to store information 315, such that the configured logics of 305 through 325 each performs their functionality (i.e., in this case, software execution) based in part upon the operation of software stored by the logic configured to store information 315. Likewise, hardware that is directly associated with one of the configured logics can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

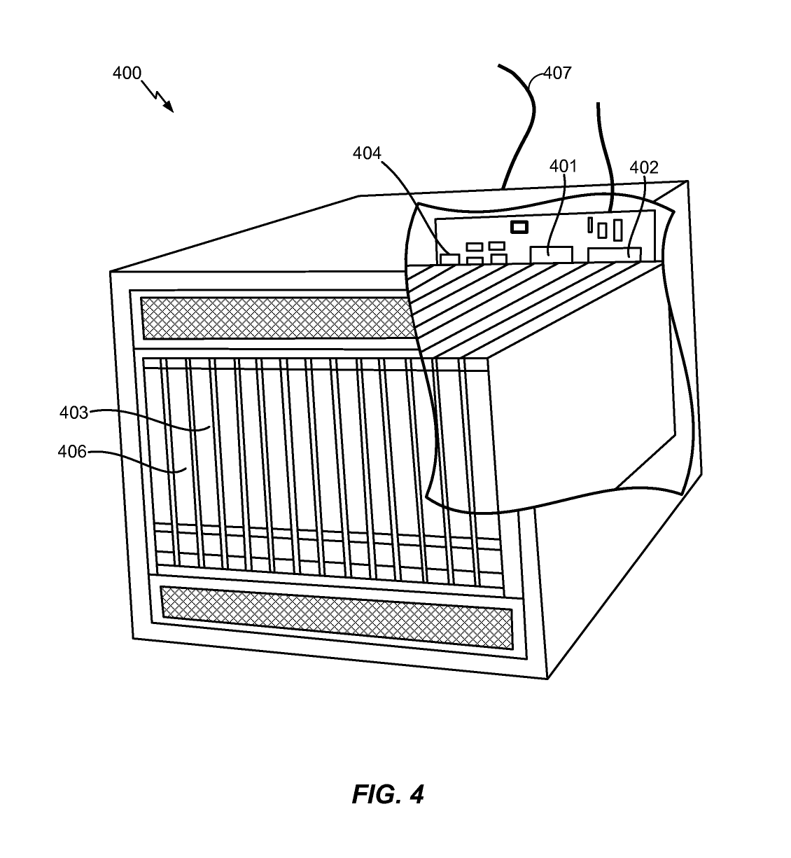

The various embodiments may be implemented on any of a variety of commercially available server devices, such as server 400 illustrated in FIG. 4. In an example, the server 400 may correspond to one example configuration of the application server 170 described above. In FIG. 4, the server 400 includes a processor 400 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communication device 300, whereby the logic configured to transmit and/or receive information 305 corresponds to the network access ports 304 used by the server 400 to communicate with the network 407, the logic configured to process information 310 corresponds to the processor 401, and the logic configuration to store information 315 corresponds to any combination of the volatile memory 402, the disk drive 403 and/or the disc drive 406. The optional logic configured to present information 320 and the optional logic configured to receive local user input 325 are not shown explicitly in FIG. 4 and may or may not be included therein. Thus, FIG. 4 helps to demonstrate that the communication device 300 may be implemented as a server, in addition to a UE implementation as in 205A or 205B as in FIG. 2.

For example, where the server 400 is configured to calculate a relative distance between a first node and a second node in a wireless network, the network access ports 404 may be configured to detect a plurality of transitions of a user device from the first node to the second node. The processor 401 may be configured to determine a relationship between the first node and the second node based on the plurality of transitions and calculate the relative distance between the first node and the second node based on the determined relationship. The network access ports 404 may be further configured to share the determined relationships and/or calculated relative distances with one or more other devices.

A server, such as IoT server 170 in FIG. 1A, may collect data from the user devices with which it is in communication. Such information may include location information of a user device, such as its GPS coordinates, an identifier of the access point, such as access point 125 in FIG. 1A, to which it is connected, an identifier of the cell tower to which it is connected, an identifier of another user device to which it is proximate, etc. The identifier of an access point may be a location identifier, such as an Access Point Name (APN) or a Media Access Control (MAC) address, as these values uniquely identify an access point.

The server can categorize the identifiers of access points reported by the user devices to determine relationships between the corresponding users. For example, the server can categorize the location identifiers of the access points by assigning a number to each location identifier. However, merely assigning random numbers to the location identifiers does not contribute to meaningful output. Likewise, assigning numbers linearly, meaning that each location identifier is assigned the next value upon entry in the system, also does not contribute to meaningful output.

Instead, the various aspects of the disclosure cluster the location identifiers and assign them numbers based on significance, location, and/or frequency of use, which allows the numeric assignations to add meaning to the output. For example, if a user device frequently transitions from access point A to access point B, the numeric assignments for these two points should indicate that the access points are related. As one option, numeric values can be assigned to the location identifiers in order of weight. Location identifiers that appear more frequently can be assigned a more significant numeric value. As another option, a graph of all location identifiers can be created. Using the graph, a transition table can be built, showing which location identifiers are related based on user devices transitioning between them. The most significant points can be taken as the basis for mapping the others, and numeric values can be assigned based on this transition map.

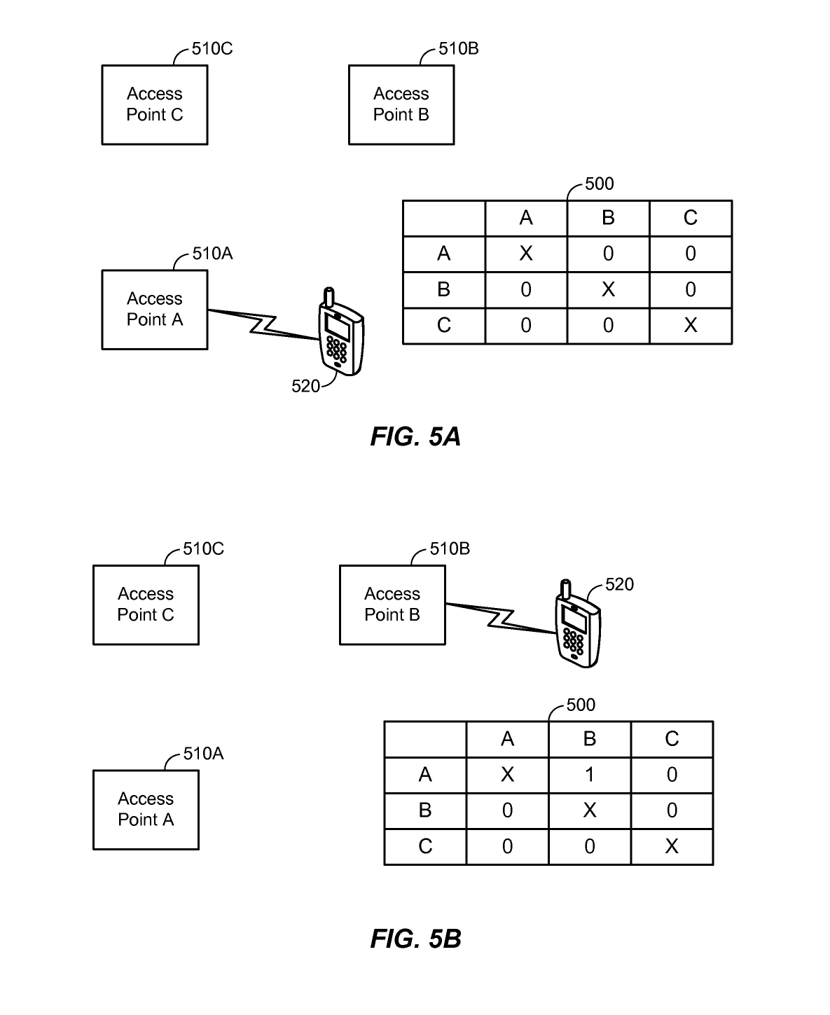

FIGS. 5A-F illustrate how an exemplary transition table 500 is populated with a count of transitions made by a user device 520 between access points A 510A to C 510C. In FIG. 5A, the exemplary transition table 500 is initialized to 0 and the user device 520 is connected to access point A 510A.

In FIG. 5B, the user device 520 has moved and is now connected to access point B 510B. The row-column pair A-B in the transition table 500 is updated from 0 to 1, indicating that the user device 520 has transitioned once from access point A 510A to access point B 510B.

In FIG. 5C, the user device 520 has moved again and is now connected to access point C 510C. The row-column pair B-C in the transition table 500 is updated from 0 to 1, indicating that the user device 520 has transitioned once from access point B 510B to access point C 510C.

In FIG. 5D, the user device 520 has moved back to access point B 510B. The row-column pair C-B in the transition table 500 is updated from 0 to 1, indicating that the user device 520 has transitioned once from access point C 510C to access point B 510B.

In FIG. 5E, the user device 520 has moved back to access point A 510A. The row-column pair B-A in the transition table 500 is updated from 0 to 1, indicating that the user device 520 has transitioned once from access point B 510B to access point A 510A.

In FIG. 5F, the user device 520 has moved back to access point B 510B. The row-column pair A-B in the transition table 500 is updated from 1 to 2, indicating that the user device 520 has transitioned from access point A 510A to access point B 510B twice.

As is apparent, while FIGS. 5A-5F illustrate three access points, that there may be any number of access points that user device 520 may transition between.

The user device 520 may store the transition table 500 locally and periodically upload it to the server, or the server may generate the transition table 500 based on transition information received from the user device 520 or the access points 510A-C. The transition information includes at least the location identifier of the new access point and optionally the time of the transition and the location identifier of the previous access point. Alternatively, the user device 520 may periodically send its geographic coordinates and/or the location identifier of its current access point to the server, and the server can determine when the user device 520 transitions from one location or access point to another.

However, the user device 520 need not send its transition information to the server. Rather, the user device 520 can store its transition table locally and identify related access points as described herein itself. The user device 520 can also share its transition table with other user devices. In that case, the user devices can aggregate the shared transition tables locally and each user device can determine relationships between access points based on their locally stored aggregated transition tables.

Where the access points 510A-C report the transition information to the server, they may simply report that the user device 520 transitioned into their coverage area and the server can determine from which access point the user device 520 transitioned. Alternatively, the access points 510A-C may be able to determine during the transition which access point was previously serving the user device 520 and report that information to the server as well.

The server can aggregate the transition tables, or transition information, from each user device in the network into a global transition table. Alternatively, the server can maintain separate transition tables for each user device in the network. Either way, the server can normalize the data (either in the global transition table or the individual transition tables), invert the normalized data, and calculate the relative distances between the access points. The calculated distances are not geo-spatial distances, but rather, geo-functional distances. That is, they show how closely related the access points are to each other. The more user devices that transition between two access points, and the more frequently the transitions, the more closely related those access points are considered to be to each other.

In another aspect, rather than a single global transition table or individual transition tables, transition tables may be built for a specific subset of user devices. For example, there may be millions of users in a given city, but only 100,000 of them may transition from a particular coffee shop's access point to a particular book store's access point. Such a relatively small number of transitions (i.e., 100,000 out of millions) may indicate that the coffee shop and the bakery are not very close, or not very related, to each other geo-functionally. In contrast, in a network of three users, such as a family network, if all three users frequently transition from a home access point to a garage access point, for example, it may indicate that the home access point and the garage access point are very close, or very related, to each other. When determining the distance between two points, the system can look at either the global transition table, the local transition table(s), or a combination of the two.

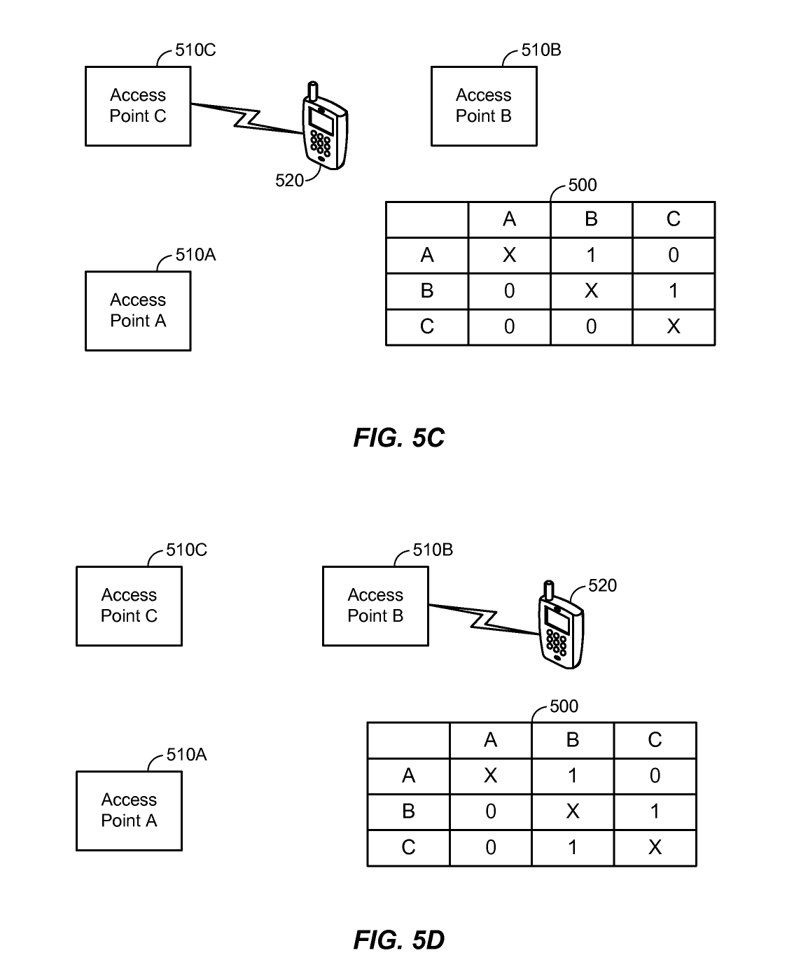

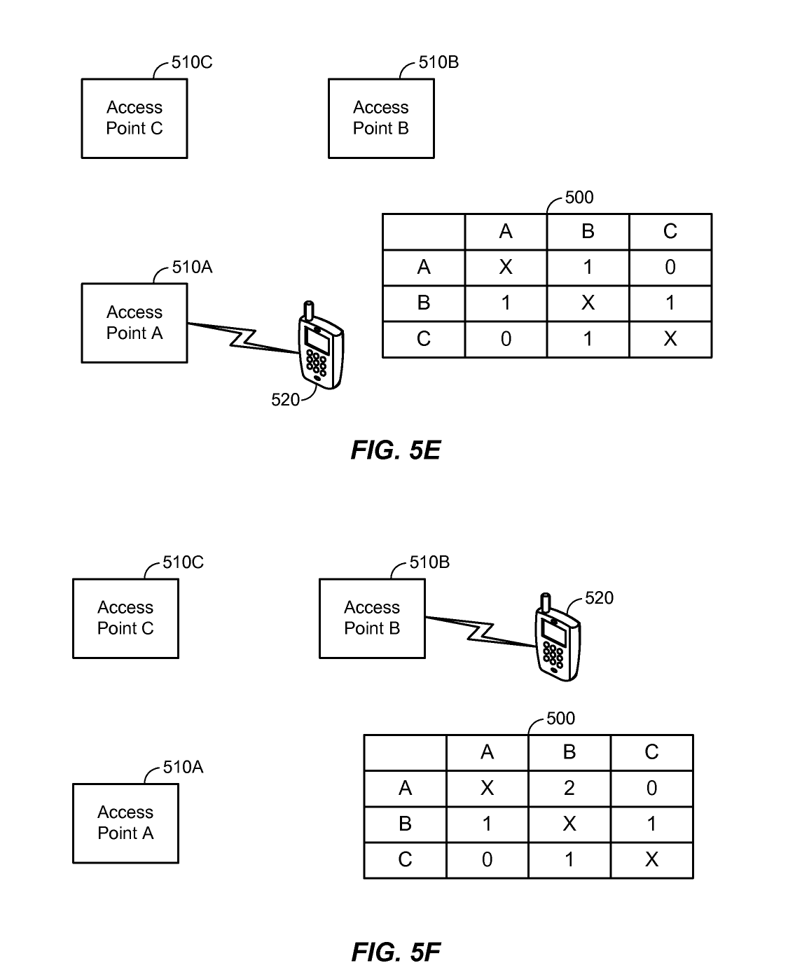

FIG. 6A illustrates an exemplary process of calculating the geo-functional distances between the access points A 510A to C 510C of FIGS. 5A-F. An exemplary global transition table 600 is illustrated as storing 10 transitions from access point A 510A to B 510B, 0 transitions from access point A 510A to access point C 510C, 15 transitions from access point B 510B to access point A 510A, 12 transitions from access point B 510B to access point C 510C, three transitions from access point C 510C to access point A 510A, and eight transitions from access point C 510C to access point B 510B.

The server generates a normalized table 610 from the global transition table 600 by dividing each value in the global transition table 600 by the largest number, here 15. Next, the server generates an inverted normalized table 620 by subtracting each number in the normalized table 610 from 1.00. FIG. 6B illustrates the inverted normalized values between access points A 510A to C 510C.

The server then calculates the geo-functional distances between each access point A 510A to C 510C using the following equations:

|A−B|=(0.34+0.00)/2=0.34/2=0.17

|A−C|=(1.00+0.80)/2=1.80/2=0.90

|B−C|=(0.20+0.45)/2=0.65/2=0.33

As was illustrated in the global transition table 600, the greatest number of transitions were between access points A 510A and B 510B (10 and 15). As shown above, the distance value between access points A 510A and B 510B is the smallest distance value, indicating that access points A 510A and B 510B have the closest geo-functional distance in the network of access points A 510A to C 510C.

Note that the server is not required to use these specific formulas. Rather, any formula that can rank the geo-functional distances between access points as a function of the number of transitions between the access points can be used.

Calculating the geo-functional distances between access points can reveal relevant information about relationships between users. For example, if a first user is connected to a first access point and a second user is connected to a second access point that is very geo-functionally near the first access point, there is a strong possibility that there is some relationship between the two users. For example, where the user devices share their transition information with each other, if two user devices discover that they are frequently connected to geo-functionally close access points, it may indicate that the user devices are related.

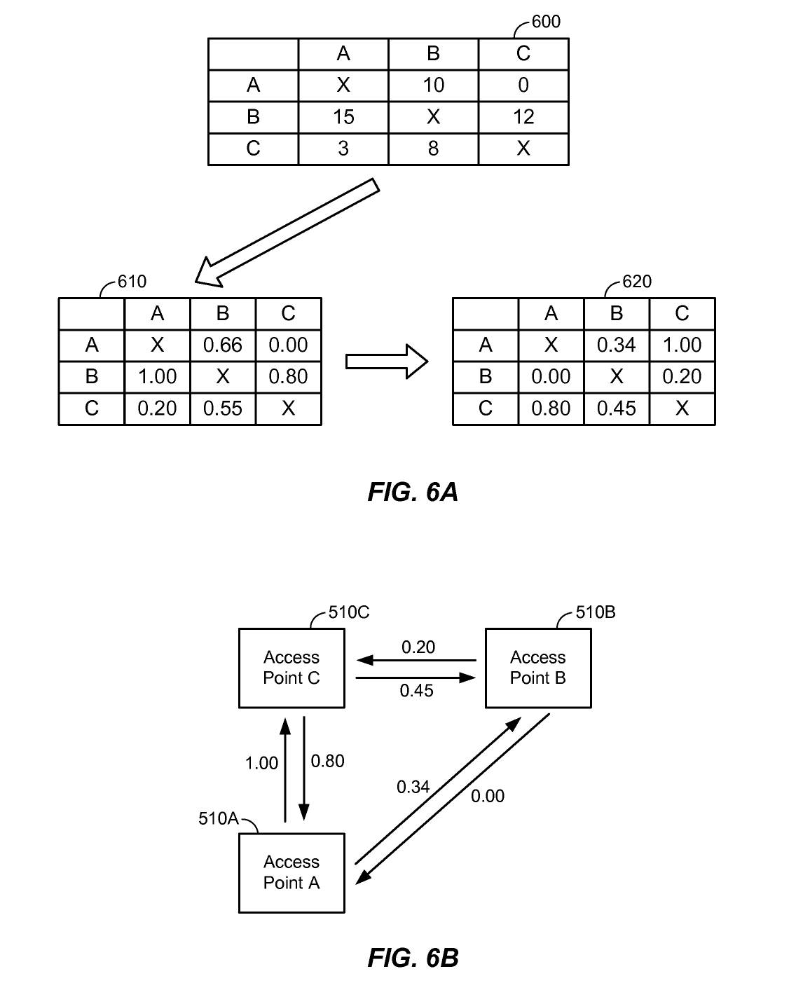

FIG. 7 illustrates a graph 700 mapping input data, i.e., transitions between access points, to centroids.

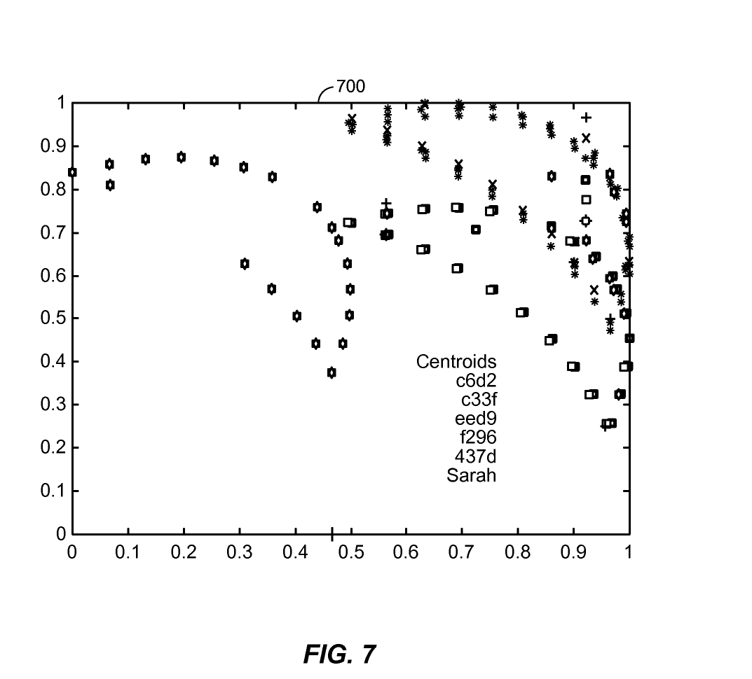

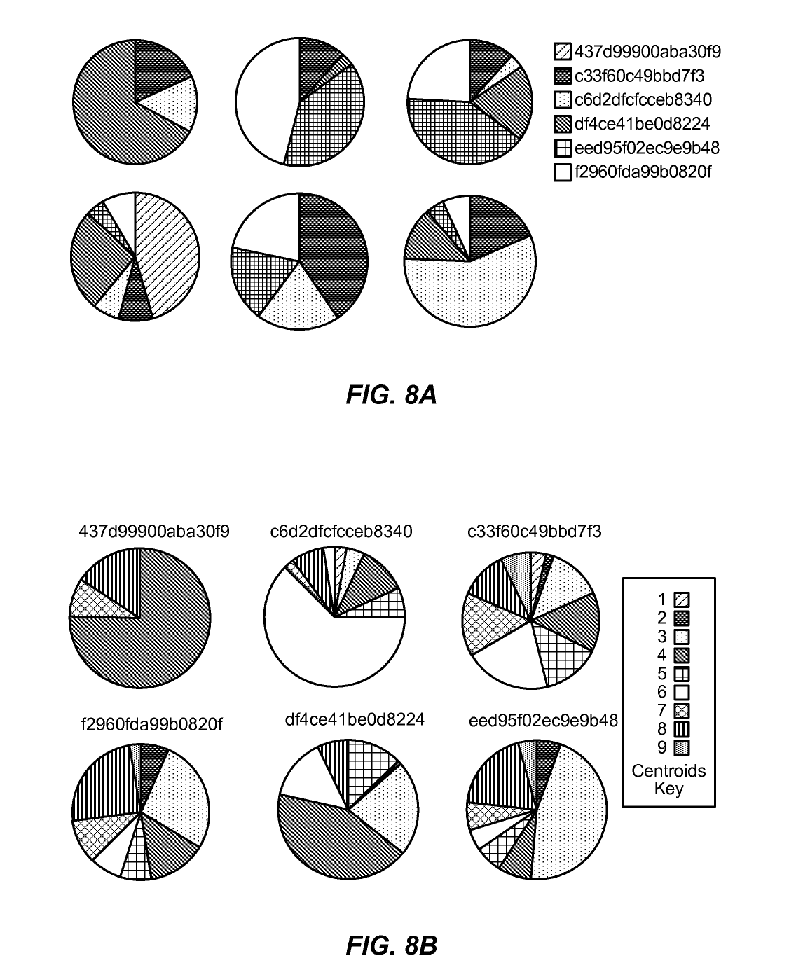

FIG. 8A illustrates an exemplary user device representation per centroid illustrated in FIG. 7. By calculating the centroid representation for each user device, it is possible to discover a correlation between user devices.

FIG. 8B illustrates an exemplary centroid representation per user device of FIG. 8A.

Although the above aspects have been described in terms of location identifiers of access points, the disclosure is not so limited. The geo-functional distance between any type of node to which a user device can connect can be calculated using the aspects described above. For example, the access points referred to above could instead be cell phone towers, proximate user devices, or even GPS satellites. Similarly, the location identifiers referred to above could be any identifier that uniquely identifies the node. Note that the physical location of the node need not be known, as the geo-functional location determination does not require the physical location of the node. However, the physical location of a node could be associated with its geo-functional location.

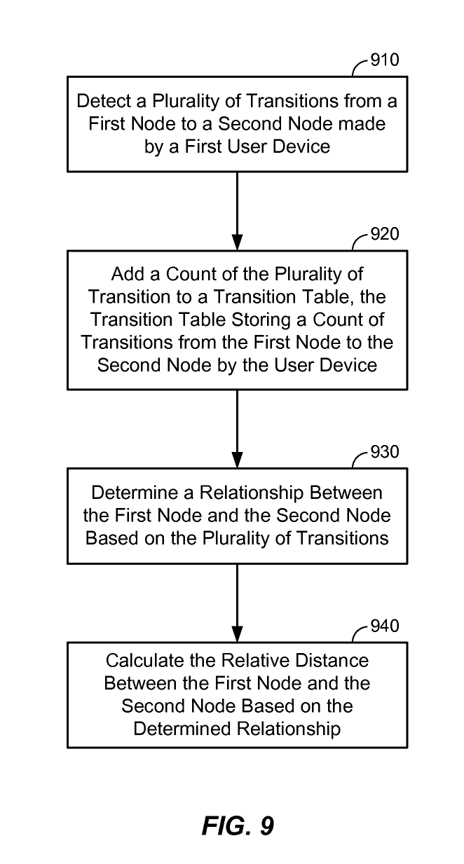

FIG. 9 illustrates an exemplary flow for calculating a geo-functional, or relative, distance between a first node and a second node. The flow illustrated in FIG. 9 may be performed by a server, such as IoT server 170 in FIG. 1A and/or server 400 in FIG. 4. Alternatively, the flow illustrated in FIG. 9 may be performed by a UE, such as UE 200A/200B. For simplicity, the flow illustrated in FIG. 9 will be described as being performed by a server, however, as noted, the disclosure is not so limited.

At 910, the server detects a plurality of transitions from a first node to a second node by a user device. The detecting may include receiving an identifier of the second node from the user device. Alternatively, the detecting may include receiving an identifier of the first node, receiving an identifier of the second node, and determining that the user device has transitioned from the first node to the second node in response to receiving the identifier of the second node after receiving the identifier of the first node. The identifier of the first node may be a location identifier. The first node may be a wireless access point or a cell phone tower. A transition may represent a handover from the first node to the second node caused by the user device moving from a coverage area of the first node to a coverage area of the second node.

At 920, the server adds a count of the plurality of transitions to either an individual transition table for the user device or a global transition table. The individual transition table may store a count of transitions from the first node to the second node made by the first user device. The global transition table may store a count of transitions from the first node to the second node made by a plurality of user devices.

At 930, the server determines a relationship between the first node and the second node based on the plurality of transitions. Various metrics may indicate the relationship between the first node and the second node. For example, a greater number of transitions between the first node and the second node may indicate a stronger relationship between the first node and the second node, and vice versa. As another example, the time of day of each transition, or the approximate time of day of a majority of the transitions, may indicate the relationship between the first node and the second node. As yet another example, the number of distinct user devices that transition from the first node to the second node may indicate the relationship between the first node and the second node. The more distinct user devices that transition between the first node and the second node, the stronger the relationship between the nodes and the more popular the location may be determined to be. The various metrics related to the plurality of transitions may be used independently or in combination to determine the relationship between the first node and the second node.

There may also, or alternatively, be semantic information associated with the nodes. For example, certain nodes may be located in the northern hemisphere and others in the southern hemisphere, or certain nodes may be in proximity to coffee shops and others to chocolatiers. In these cases, one or more metrics can be defined indicating the affinity between the nodes based on the semantic information associated with the nodes.

At 940, the server calculates the geo-functional, or relative, distance between the first node and the second node based on the determined relationship. A stronger relationship between the first node and the second node indicates a closer relative distance between the first node and the second node. The calculating may include calculating the relative distance between the first node and the second node based on a number of a plurality of user devices transitioning between the first node and the second node compared to a number of the plurality of user devices. That is, a larger percentage of the user devices in a network transitioning between the two nodes indicates a closer relative distance than a smaller percentage of the user devices in the network transitioning between the nodes.

The calculating at 940 may include normalizing a count of the plurality of transitions from the first node to the second node to a first normalized value from zero to one, normalizing a count of a plurality of transitions from the second node to the first node to a second normalized value from zero to one, inverting the first normalized value, inverting the second normalized value, determining an average of the first normalized value and the second normalized value, and setting the average as the relative distance. A smaller relative distance can indicate a higher correlation between the first node and the second node.

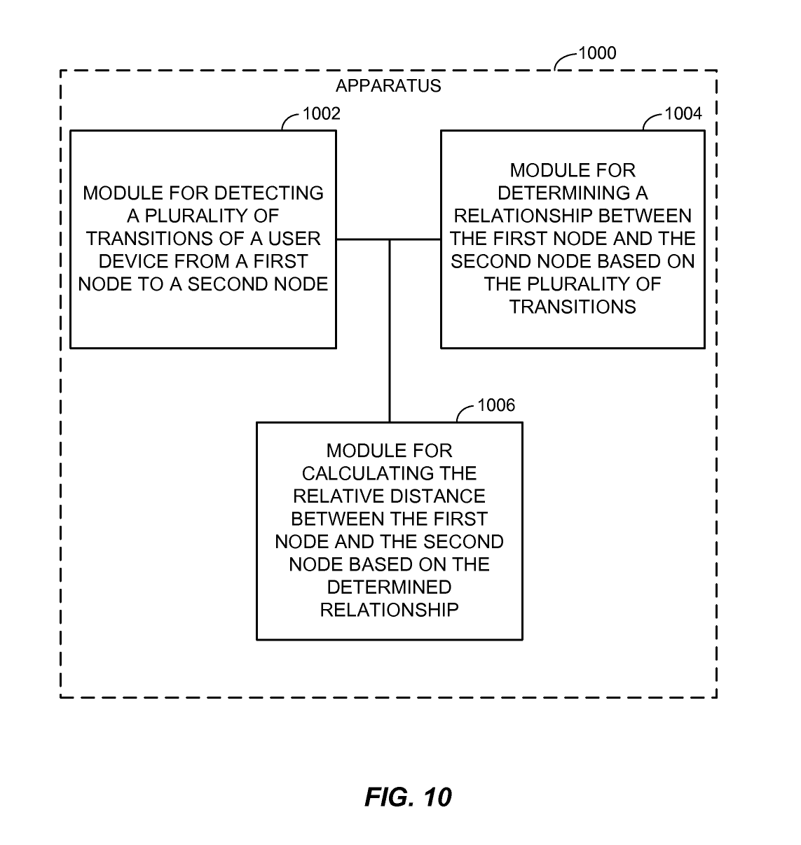

FIG. 10 illustrates an example base station apparatus 1000 represented as a series of interrelated functional modules. A module for detecting 1002 may correspond at least in some aspects to, for example, a communication device as discussed herein, such as transceiver 206 in FIG. 2 or network access ports 404 in FIG. 4. A module for determining 1004 may correspond at least in some aspects to, for example, a processing system as discussed herein, such as ASIC 208 in FIG. 2 or processor 401 in FIG. 4. A module for calculating 1006 may correspond at least in some aspects to, for example, a processing system as discussed herein, such as ASIC 208 in FIG. 2 or processor 401 in FIG. 4.

The functionality of the modules of FIG. 10 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 10, as well as other components and functions described herein, may be implemented using any suitable means. Such means also may be implemented, at least in part, using corresponding structure as taught herein. For example, the components described above in conjunction with the “module for” components of FIG. 10 also may correspond to similarly designated “means for” functionality. Thus, in some aspects one or more of such means may be implemented using one or more of processor components, integrated circuits, or other suitable structure as taught herein.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically and/or optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method for calculating a relative distance between a first node and a second node in a wireless network, comprising:
detecting a plurality of transitions of a user device from the first node to the second node;
determining a relationship between the first node and the second node based on the plurality of transitions; and
calculating the relative distance between the first node and the second node based on the determined relationship.

2. The method of claim 1, further comprising:
adding a count of the plurality of transitions to a transition table, the transition table storing a count of transitions of the user device from the first node to the second node.

3. The method of claim 1, wherein a greater number of transitions between the first node and the second node indicates a stronger relationship between the first node and the second node.

4. The method of claim 1, wherein a stronger relationship between the first node and the second node indicates a closer relative distance between the first node and the second node.

5. The method of claim 1, wherein the detecting comprises receiving an identifier of the second node from the user device.

6. The method of claim 1, wherein the detecting comprises:
receiving an identifier of the first node;
receiving an identifier of the second node; and
determining that the user device transitioned from the first node to the second node in response to receiving the identifier of the second node after receiving the identifier of the first node.

7. The method of claim 6, wherein the identifier of the first node comprises a location identifier.

8. The method of claim 1, wherein the first node comprises a wireless access point or a cell phone tower.

9. The method of claim 1, wherein a transition from the first node to the second node represents a handover from the first node to the second node caused by the user device moving from a coverage area of the first node to a coverage area of the second node.

10. The method of claim 1, wherein the calculating further comprises calculating the relative distance between the first node and the second node based on a number of a plurality of user devices transitioning between the first node and the second node compared to a total number of the plurality of user devices in the wireless network.

11. The method of claim 1, wherein the relative distance comprises a parameter representing a measure of the relationship between the first node and the second node.

12. The method of claim 1, wherein the calculating comprises:
normalizing a count of the plurality of transitions from the first node to the second node to a first normalized value from zero to one;
normalizing a count of a plurality of transitions from the second node to the first node to a second normalized value from zero to one;
inverting the first normalized value;
inverting the second normalized value;
determining an average of the first normalized value and the second normalized value; and
setting the average as the relative distance.

13. The method of claim 1, wherein a smaller relative distance indicates a higher correlation between the first node and the second node.

14. The method of claim 1, wherein the method is performed by a server.

15. An apparatus for calculating a relative distance between a first node and a second node in a wireless network, comprising:
a wireless transceiver configured to detect a plurality of transitions of a user device from the first node to the second node; and
a processor in communication with the wireless transceiver, the processor configured to determine a relationship between the first node and the second node based on the plurality of transitions, and to calculate the relative distance between the first node and the second node based on the determined relationship.

16. The apparatus of claim 15, wherein the processor is further configured to:
add a count of the plurality of transitions to a transition table, the transition table storing a count of transitions of the user device from the first node to the second node.

17. The apparatus of claim 15, wherein a greater number of transitions between the first node and the second node indicates a stronger relationship between the first node and the second node.

18. The apparatus of claim 15, wherein a stronger relationship between the first node and the second node indicates a closer relative distance between the first node and the second node.

19. The apparatus of claim 15, wherein the wireless transceiver being configured to detect comprises the wireless receiver being configured to receive an identifier of the second node from the user device.

20. The apparatus of claim 15, wherein the wireless transceiver being configured to detect comprises the wireless transceiver being configured to:
receive an identifier of the first node; and
receive an identifier of the second node,
wherein the processor is configured to determine that the user device transitioned from the first node to the second node in response to the wireless transceiver receiving the identifier of the second node after receiving the identifier of the first node.

21. The apparatus of claim 20, wherein the identifier of the first node comprises a location identifier.

22. The apparatus of claim 15, wherein the first node comprises a wireless access point or a cell phone tower.

23. The apparatus of claim 15, wherein a transition from the first node to the second node represents a handover from the first node to the second node caused by the user device moving from a coverage area of the first node to a coverage area of the second node.

24. The apparatus of claim 15, wherein the processor being configured to calculate further comprises the processor being configured to calculate the relative distance between the first node and the second node based on a number of a plurality of user devices transitioning between the first node and the second node compared to a total number of the plurality of user devices in the wireless network.

25. The apparatus of claim 15, wherein the relative distance comprises a parameter representing a measure of the relationship between the first node and the second node.

26. The apparatus of claim 15, wherein the processor being configured to calculate further comprises the processor being configured to:
normalize a count of the plurality of transitions from the first node to the second node to a first normalized value from zero to one;
normalize a count of a plurality of transitions from the second node to the first node to a second normalized value from zero to one;
invert the first normalized value;
invert the second normalized value;
determine an average of the first normalized value and the second normalized value; and
set the average as the relative distance.

27. The apparatus of claim 15, wherein a smaller relative distance indicates a higher correlation between the first node and the second node.

28. The apparatus of claim 15, wherein the apparatus comprises a server.

29. An apparatus for calculating a relative distance between a first node and a second node in a wireless network, comprising:
means for detecting a plurality of transitions of a user device from the first node to the second node;
means for determining a relationship between the first node and the second node based on the plurality of transitions; and
means for calculating the relative distance between the first node and the second node based on the determined relationship.

30. A non-transitory computer-readable medium for calculating a relative distance between a first node and a second node in a wireless network, comprising:
at least one instruction to detect a plurality of transitions of a user device from the first node to the second node;
at least one instruction to determine a relationship between the first node and the second node based on the plurality of transitions; and
at least one instruction to calculate the relative distance between the first node and the second node based on the determined relationship.
